(19) United States
(12) Patent Application Publication
(10) Pub. No.: US 2022/0278393 A1
(43) Pub. Date: Sep. 1, 2022

(54) Battery cooling module and device, and corresponding battery

(71) Applicant: SOGEFI AIR & COOLING, GUYANCOURT (FR)

(72) Inventors: Nicolas BECKER, PORTE-DU-RIED (FR); Arnaud SCHUB, INGERSHEIM (FR); Dominique MEYER, WIHR-AU-VAL (FR); Maxime LANGOT, SOULTZ-HAUT-RHIN (FR)

(21) Appl. No.: 17/629,103

(22) PCT Filed: Jul. 29, 2020
(86) PCT No.: PCT/EP2020/071396

§ 371 Date: Jan. 21, 2022

(30) Foreign Application Priority Data
Jul. 30, 2019 (FR) FR1908679

(51) Int. Cl. H01M 10/6568; H01M 10/613; H01M 10/625; H01M 10/6556; H01M 10/6554

(52) U.S. Cl. CPC H01M 10/6568; H01M 10/613; H01M 10/625; H01M 10/6556; H01M 10/6554; H01M 2220/20

(57) ABSTRACT

The present invention relates to a cooling module (1) for electrical battery cells, comprising a main body (3) in the form of a composite plate and incorporating at least one circuit (4) for the circulation of a heat transfer fluid, between a base plate (6) made of a rigid material with low thermal conductivity and at least one covering plate (8) made of a material with high thermal conductivity, which is intended to come into surface contact with cells of the battery to be cooled, each assembly [cover plate (8)/duct circuit (4)] forming a temperature-controlled reception site. The module (1) is characterised in that it also comprises, along one of the lateral sides (3′) of the composite plate (3), a formation (10) which is prominent, which incorporates supply and removal duct portions (11, 11′) connected, respectively, to the fluid inlet and outlet of the or each of the duct circuits (4) of the composite plate (3), which is made of a material with low thermal conductivity, and at least one part of which is produced in one piece with the base plate (6) of the main body (3).

The present invention concerns the field of autonomous electrical energy sources, in particular those on board automobile vehicles, of the battery unit type with integral temperature regulation or control means, and has for objects a cooling module for the cells of such a battery, a battery unit including such modules and a hybrid or electric automobile vehicle including at least one such unit.

Hybrid/electric vehicles are equipped with a battery for storing the electrical energy necessary for their operation. What is currently at stake necessitates optimizing the design of the battery units, also known as “battery packs”, in order to obtain from them the best performance in terms of service life (charging/discharging) and autonomy of travel.

The batteries employed ideally need to operate at temperatures between 10° C. and 30° C., especially high storage density batteries, for example of Li-ion or Li-polymer type. Too low a temperature impacts the autonomy and too high a temperature impacts the service life of the batteries. It is therefore necessary to regulate the temperature of such batteries optimally.

In the context of applications on board vehicles, there exist air-cooled battery solutions but the exchange of heat remains somewhat limited. The current trend is to use a heat transfer fluid in order to improve the exchanges of heat and to increase the effectiveness of regulation.

Moreover, the housings receiving these batteries may at present be formed directly by a part of the vehicle or consist in cavities formed in a structural part of that vehicle. However, these solutions are not very flexible in terms of layout and make maintenance difficult. Solutions with autonomous battery packs that are not integrated into the structure of the vehicle are therefore to be preferred.

Numerous designs exist in the prior art: they use metal (steel, aluminum, etc.) solutions with a distribution of heat transfer fluid via hoses to cooling plates disposed inside the battery pack, on which rest the modules combining the cells or elements of the battery.

This results in a complex construction, formed by assembling a large number of parts, necessitating the production of numerous sealed connections of dedicated ducts during production (the resistance to ageing of which may be problematic) and constituting a bulky, multi-component structure that is not optimized in terms of thermal efficiency.

Moreover, the casing of the battery unit of these known solutions being made of metal (preferably of aluminum), it is not able to isolate the battery pack thermally and electrically from the external environment, also has a high unit cost and is moreover subject to corrosion.

Moreover, no effective measure is provided in these known solutions to preserve the battery in the event of heat transfer liquid leaking inside the casing.

From French patent applications FR 3 062 749 and FR 3 062 521 in the name of the applicant there are already known battery units integrating cooling means and means for circulation/distribution of heat transfer fluid directly in the body of the casing. Although enabling the aforementioned limitations to be overcome, these battery units have a fixed structure, cannot be adapted, and are not suitable for use with an existing casing. Moreover, the parts forming the casing may have large dimensions and complex structures.

From the document FR 3 003 938 there is known a heat transfer plate for batteries with a body based on plastic material on which is mounted a metal plate, heat transfer fluid circulation channels being formed in the basic body to form closed ducts in conjunction with the metal plate.

Separate connectors for connecting the aforementioned ducts are fastened to the metal plate, with a seal between them, by mechanical fixing, die stamping or by using an intermediate connecting part.

Over and above a dedicated fastening, a loss of usable area in terms of cooling and a direct and individual exposure to external aggression, the arrangement of these connectors leads to connection from above to fluid feed and evacuation ducts that can interfere with the electrical connection means of the cells/modules of the battery.

Finally, from the document WO 2019/046012 there is known a battery cooling system with a plurality of cooling plates each connected by a pair of tubular elbow connectors to common heat transfer fluid feed and evacuation lines in the form of an aluminum extrusion including two longitudinal chambers to which the connectors are connected.

This results in a complex arrangement of a large number of individual connectors and the imposition of an obligatory configuration on all of the cooling plates.

An aim of the invention is to overcome at least the main limitations of the aforementioned prior art.

To this end, the invention has for object a cooling module for cells or module(s) of an electric battery, in particular a hybrid or electric vehicle battery, comprising a main body in the form of a composite plate, preferably of rectangular shape and integrating at least one circuit for the circulation of a heat transfer fluid with a fluid inlet and a fluid outlet, this composite plate comprising a baseplate made of a rigid material with low thermal conductivity, in which is formed an array of channels, and at least one covering plate made of a material with high thermal conductivity, which is mounted on the baseplate and forms an at least peripheral seal, which through cooperation with the channels of the baseplate, forms the duct or ducts or duct segment(s) of the circuit(s) and is intended to come into surface contact with cells or at least one module of the battery to be cooled, each [cover plate/circuit of duct(s)] assembly forming a temperature-controlled reception site,

module characterized in that it also comprises, along one of the lateral sides of the composite plate, a protruding formation that is inclined relative to said composite plate, which integrates feed and evacuation duct portions respectively connected to the fluid inlet and to the fluid outlet of the or each of the circuits of duct(s) of the composite plate, which is made of a material with low thermal conductivity, and at least one part of which, preferably a major part including channels corresponding to the feed and evacuation duct portions, and is produced in one piece with the baseplate of the main body.

The invention is also directed to a cooling device comprising at least two of the aforementioned modules, a battery unit integrating cooling modules of the aforementioned type and an automobile vehicle including at least one such battery.

The invention will be better understood thanks to the following description, which relates to preferred embodiments provided by way of nonlimiting example and explained with reference to the appended schematic drawings, in which:

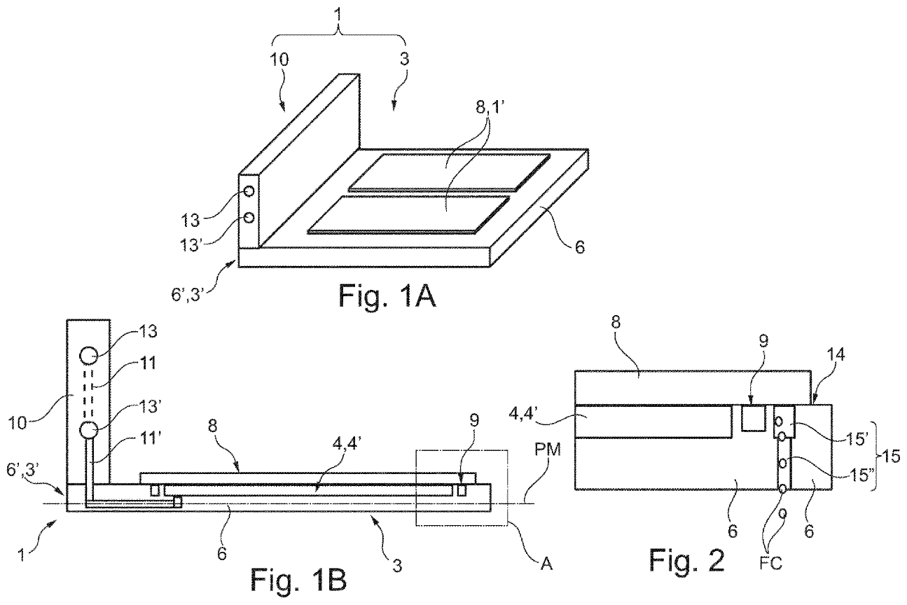

FIG. 1A and

FIG. 1B are schematic views in perspective and in section of a cooling module in accordance with a first embodiment of the invention;

FIG. 2 is a view to a different scale of the detail A from FIG. 1B;

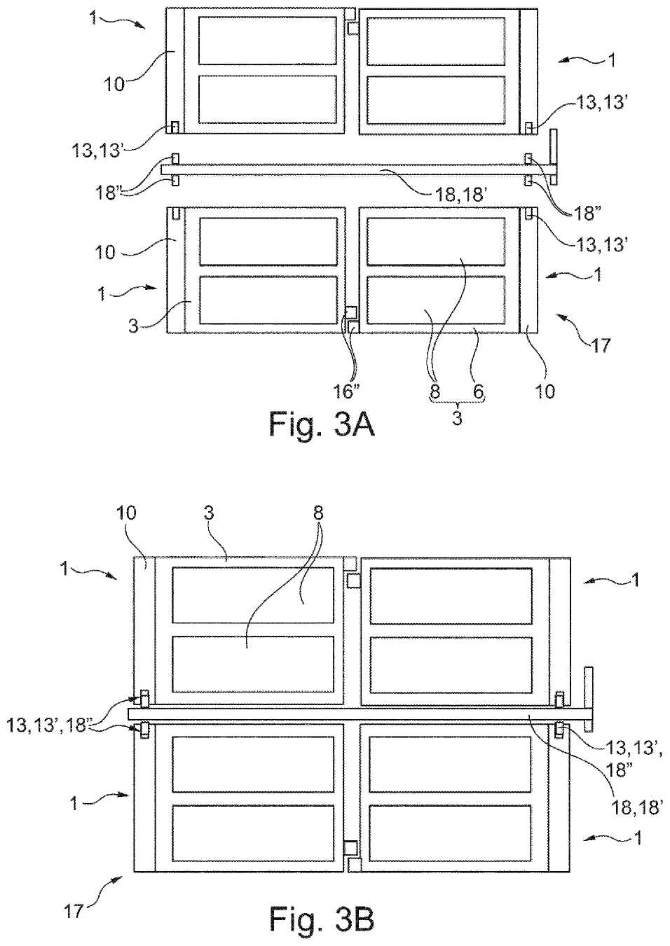

FIG. 3A and

FIG. 3B are views from above of a battery cooling device in the exploded state (3A) and in the assembled state (3B) comprising four modules as represented in FIGS. 1A and 1B;

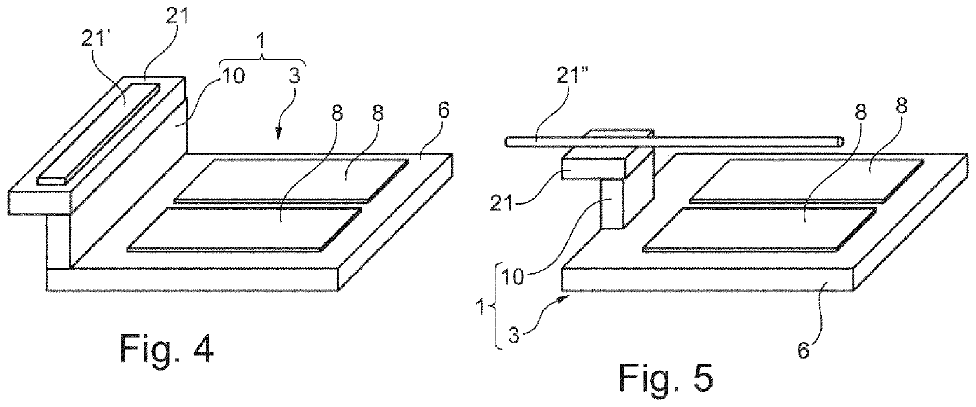

FIG. 4 and

FIG. 5 are views in perspective of variant embodiments of the modules from FIGS. 1A and 1B;

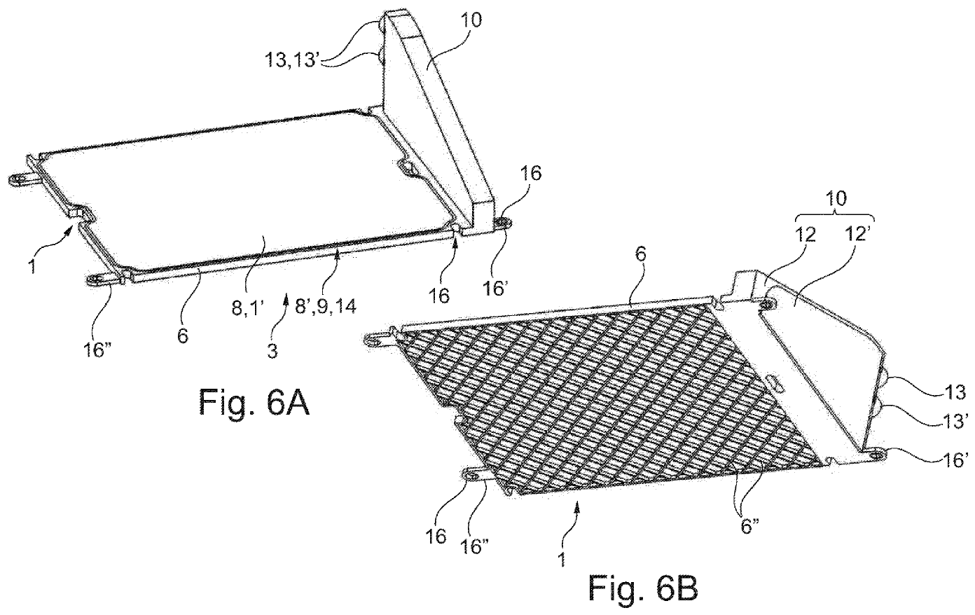

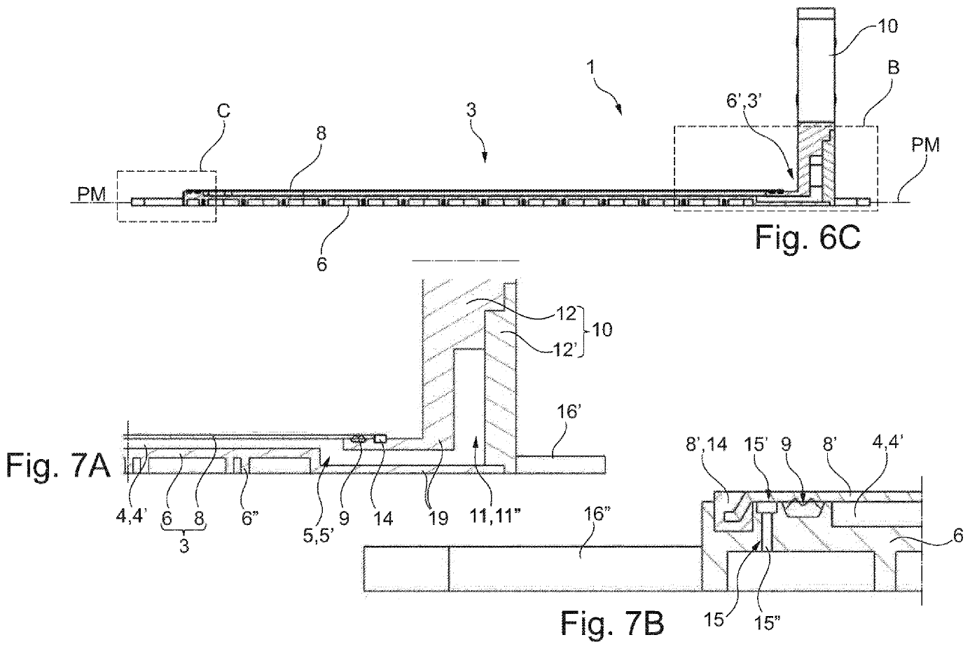

FIG. 6A,

FIG. 6B and

FIG. 6C are respectively views in perspective from above (6A), in perspective from below (6B) and in section (6C) of a cooling module in accordance with another embodiment of the invention;

FIG. 7A and

FIG. 7B are views to a different scale of the details B and C from FIG. 6C;

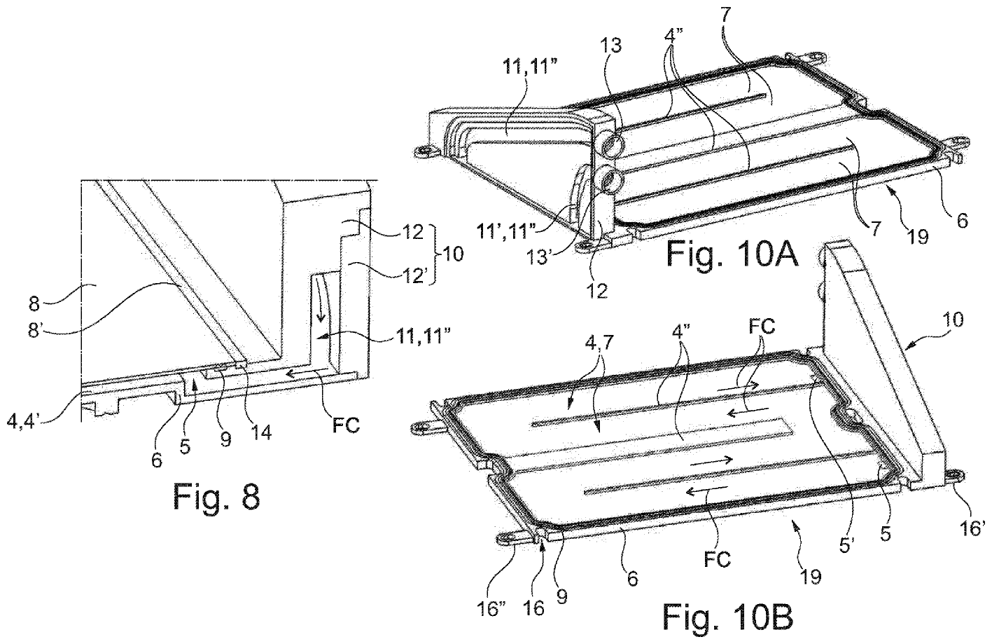

FIG. 8 is a view in perspective of the detail B represented in FIG. 7A;

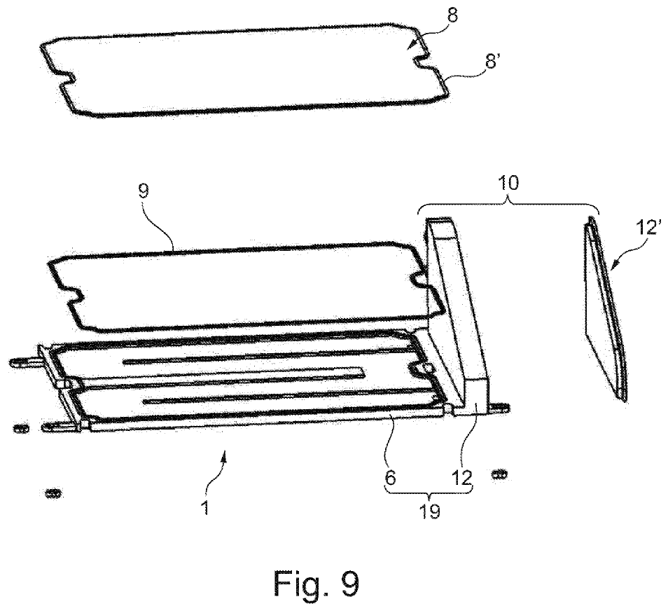

FIG. 9 is an exploded view of the cooling module represented in FIG. 6;

FIG. 10A and

FIG. 10B are views in perspective from two different angles of the molded monobloc part simultaneously forming base body and baseplate of the cooling module from FIGS. 6 and 9;

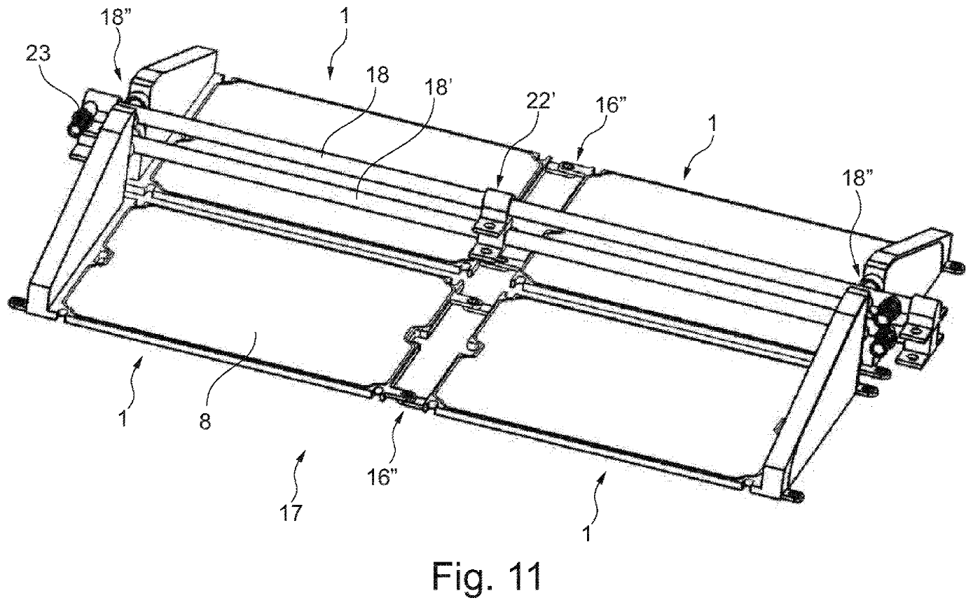

FIG. 11 is a view in perspective of a cooling device in accordance with the invention formed by the mechanical and fluidic assembly of four cooling modules as represented in FIGS. 6 and 9;

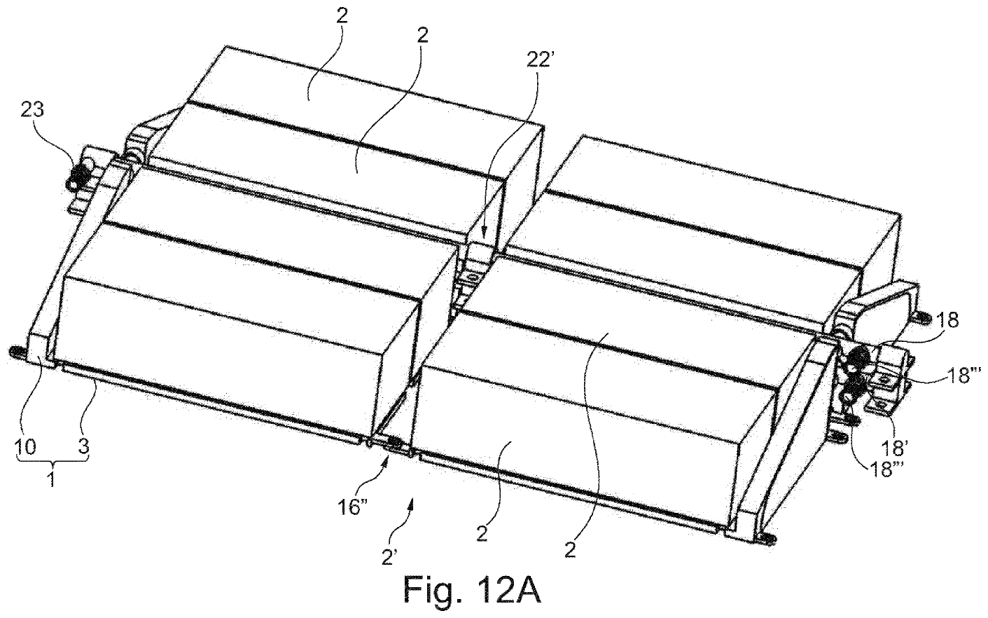

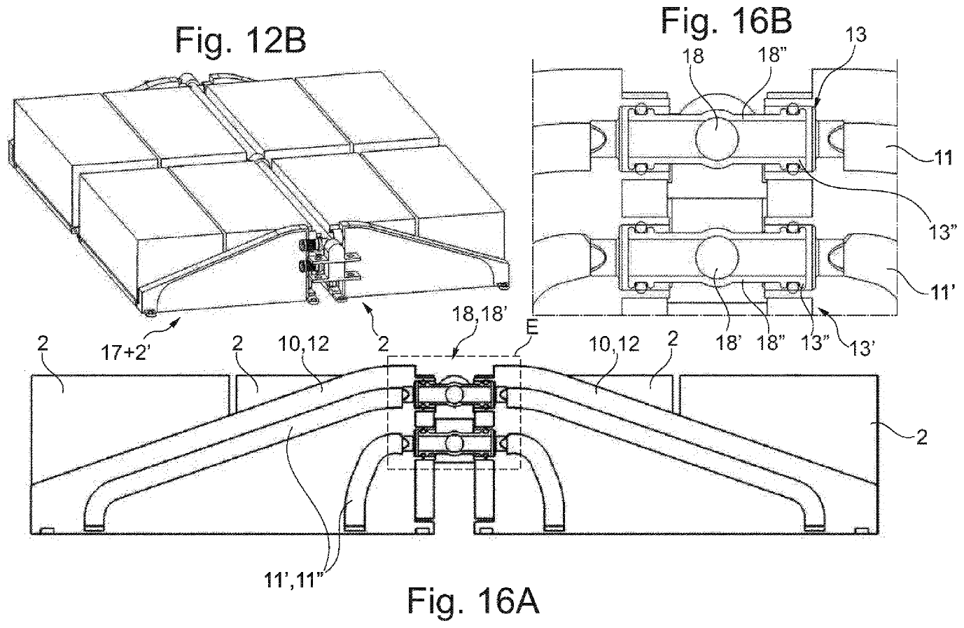

FIG. 12A,

FIG. 12B and

FIG. 12C are views in perspective from different angles (FIGS. 12A and 12B) and from above (FIG. 12C) of the cooling device from FIG. 11 equipped with eight battery modules (in FIG. 12C the feed duct is cut on a plane parallel to the plane on which the battery modules rest);

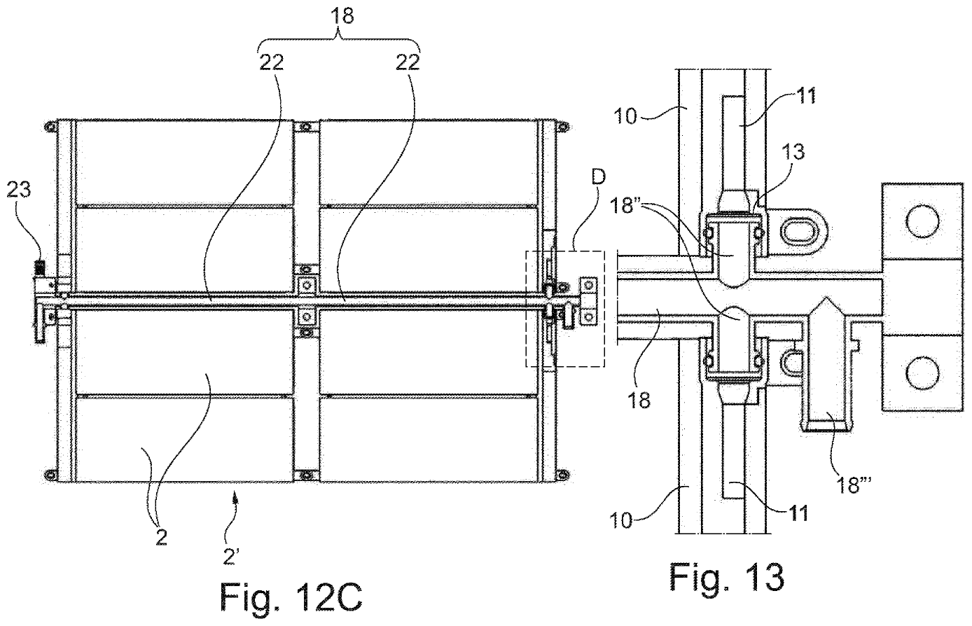

FIG. 13 is a view to a different scale of the detail D from FIG. 12C;

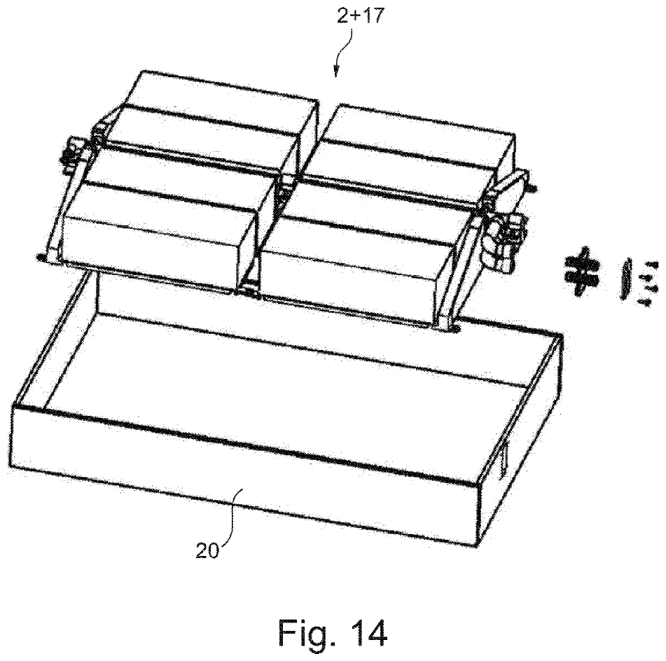

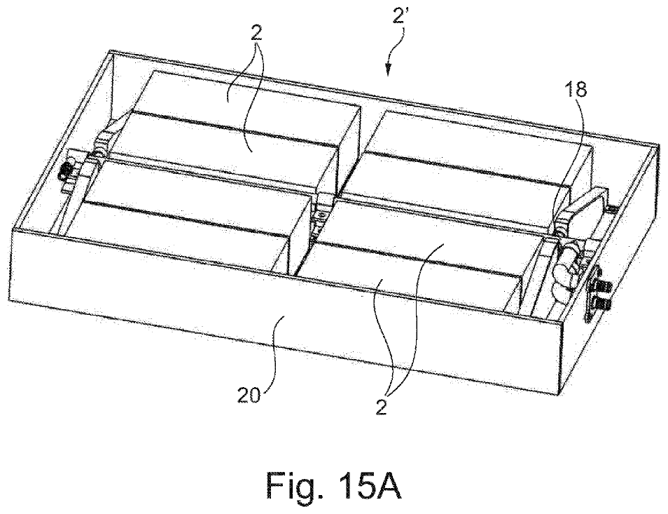

FIG. 14 is a view in perspective illustrating the mounting of the assembly formed by the battery modules and the cooling device and illustrated in FIG. 12 in a protection casing (here the bottom tray of a two-part casing—the top closure lid is not represented);

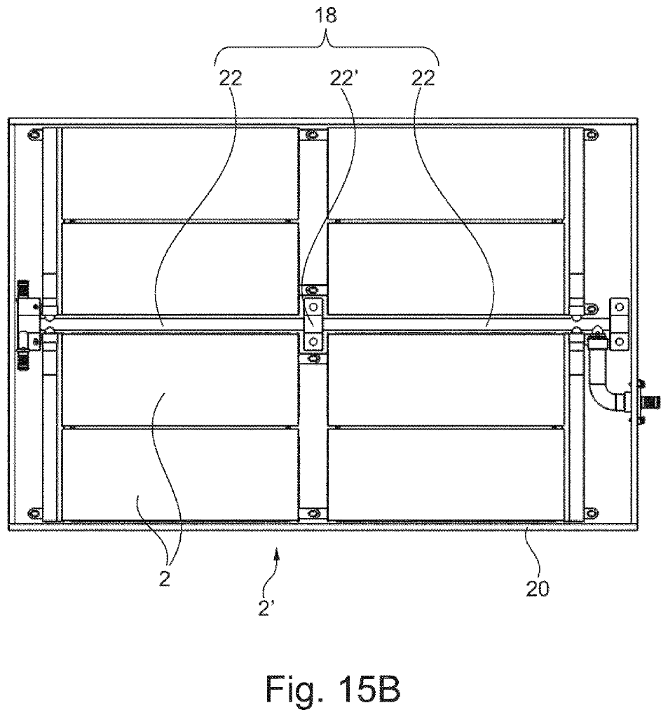

FIG. 15A and

FIG. 15B are views from above in perspective (15A) and in elevation (15B) of a battery unit resulting from the mounting operation from FIG. 14;

FIG. 16A is a view in elevation in the direction Z of the cooling module provided with battery modules and represented in FIG. 12B, the complementary plates of the protruding formations of the modules being removed, and

FIG. 16B is a view to a different scale of the detail E from FIG. 16A.

FIGS. 1 to 9 illustrate in the form of different constructive variants a cooling module 1 for cells or modules 2 of an electric battery 2′, in particular a hybrid or electric vehicle battery, comprising a main body 3 in the form of a preferably rectangular composite plate integrating at least one circuit 4 for the circulation of a heat transfer fluid with a fluid inlet 5 and a fluid outlet 5′, this composite plate 3 comprising a baseplate 6 made of a rigid material of low thermal conductivity in which is formed an array of channels 7 and at least one covering plate 8 made of a material of high thermal conductivity that is mounted on the baseplate 6 with at least a peripheral seal 9 and that forms by cooperation with the channels 7 of the baseplate 6 the duct or ducts 4 or duct segments 4′ of the circuit or circuits and is intended to come into surface contact with the cells or at least one module 2 of the battery 2′ to be cooled, each [covering plate 8/circuit of duct(s) 4] assembly forming a temperature-controlled receiving site 1′.

According to the invention, said module 1 also comprises along one of the lateral sides 3′ of the composite plate 3 a formation 10 that protrudes and is inclined relative to said composite plate 3 and which integrates portions of feed and evacuation ducts 11, 11′ respectively connected to the fluid inlet 5 and to the fluid outlet 5′ of the or each of the circuit(s) of duct(s) 4 of the composite plate 3, which is made of a material of low thermal conductivity, and on which at least a part, preferably a major part 12 comprising channels 11″ corresponding to the feed duct 11 and evacuation duct 11′ portions, is made in one piece with the baseplate 6 of the main body 3.

Thanks to these arrangements it is possible to provide a cooling module 1 in which the possibility of heat exchange between the fluid and the external environment is concentrated at the level of the covering plate or plates 8 on which the cells rest, arranged as one or more modules 2. Moreover, not only the integral circuit(s) 4 feeding the heat transfer fluid in contact with the plate or plates 8 (via duct segments 4′ interleaved between the plates 6 and 8) are structurally integrated in the module 1, but also the duct portions 11 and 11′ making the fluidic connection between the circuit(s) 4 and the external feed and evacuation lines 18, 18′.

Thus any specific duct or tube connection at the level of the module 1 is avoided, the exposure of the circulation paths is limited, and the fluidic connection of the module 1 to the exterior is made at one end of the latter, outside the zone receiving the cells or modules 2 (freed up receiving space) and at a distance (height offset) relative to the bearing plane provided by the or each covering plate 8.

A high thermal conductivity λ, and more generally a good transfer of heat between the fluid FC and the cells or modules 2, is achieved by using for the or each covering plate 8 a material that is inherently a good conductor of heat (a metal plate for example), of small thickness, in combination with a maximum area of contact and an optimized quality of contact between this plate 8 and the cells.

For its part, the low thermal conductivity can be achieved by using a material that is weakly thermally conductive, or even thermally insulating, in combination with a relatively great thickness of the wall of the surface element 9.

There is typically understood herein by high thermal conductivity λ values of λ such that λ>50 W·m⁻¹·K⁻¹, preferably λ>100 W·m⁻¹·K⁻¹, and by low thermal conductivity λ, values of λ such that λ<1 W·m⁻¹·K⁻¹, preferably λ<0.5 W·m⁻¹·K⁻¹.

The material with good thermal conductivity advantageously has a conductivity between 100 W/m/K and 300 W/m/K, typically 200 W/m/K like aluminum. In an equivalent manner, the material with low thermal conductivity has a conductivity between 0.05 W/m/K and 0.5 W/m/K, typically 0.2 W/m/K like GF30 PP plastic.

In the context of the present invention, the greater the difference in thermal conductivity between the covering plate 8 (of high thermal conductivity—for example a thin metal plate) and the baseplate 6 (of low thermal conductivity—for example a thick plastic material wall), the greater the beneficial effect of the invention.

As mentioned hereinabove, the material, preferably aluminum, of the covering plate 8 may equally be a non-metal and for example consist in a thermoplastic or thermosetting material charged with additives to increase its thermal conductivity.

The covering plate 8 may instead equally well be of a supple or flexible kind to adapt to and to compensate flatness defects of the modules whilst being a good conductor of heat (for example silicone, preferably charged).

The protruding formation 10 preferably takes the form of a plate portion extending substantially perpendicularly to the median plane PM of the composite plate 3 and extending in continuity therewith a lateral edge 6′ of the baseplate preferably an edge corresponding to a width of the rectangle formed by the composite plate 3.

The formation 10 therefore constitutes a lateral wall with respect to the plate 3, these two elements together forming an L-section angle-iron structure that can easily be accommodated in a casing, resting on the bottom of the latter and against a lateral wall of said casing.

Moreover, and advantageously, the protruding formation 10 is provided at the level of the ends of the portions of feed and evacuation duct(s) 11, 11′ that are situated opposite their ends communicating with the fluid inlet 5 and the fluid outlet 5′ of the or each circuit of ducts 4 integrated into the composite plate 3, feed and evacuation ports or connectors 13, 13′ offset relative to the median plate PM of the composite plate 3, advantageously situated at a distance above the covering plate 8 concerned and discharging laterally from said formation 10, for example from a lateral edge surface of the latter (FIGS. 1, 6 and 10).

To facilitate the manufacture of the cooling module there may be provision for the protruding formation 10, integrating portions of feed duct(s) 11 and evacuation duct(s) 11′ and having a combined constitution in the form of a plate portion, to have a composite structure and to comprise a base body 12 in which are formed channels 11″ corresponding to the portions of feed duct(s) 11 and evacuation duct(s) 11′ and a complementary plate 12′ delimiting through cooperation with said channels 11″ said portions of duct(s) 11 and 11′, the inlet connectors or ports 13 and the outlet connectors or portions 13′ of the latter discharging laterally at the level of an edge surface of said plate portion 10 (FIGS. 6B, 7A, 8, 9 and 10A).

When the main body 3 has a rectangular shape, the lateral side 3′ including the protruding formation 10 in the form of a wall or of a plate portion is preferably one of the shorter sides of said rectangle.

This wall or plate portion 10 integrating the duct portions 11 and 11′ may have a length equal to or less than the dimension of the lateral side 3′, depending on the imposed overall size, the fluid connection necessities, economizing on material or the like.

Of course, the plate 10, which may also serve as a structural element, abutment and/or lateral support for the cooling module 1 and possibly a stop wall for the cells, may be a separate part mounted on one side of the baseplate 6 and fastened to it by nesting, gluing, welding or otherwise, with a seal produced between the inlet/outlet 5, 5′ and the duct portions 11, 11′.

Nevertheless, the baseplate 6 and the base body 12 (of the composite plate 10) preferably consist in a monobloc part 19 molded from thermoplastic material, the or each covering plate 8 consisting in a metal, preferably aluminum, plate.

The formation 10 in the form of a plate or a wall can have different shapes and varying contours, by necessity, by saving of material, by ease of construction or by considerations of overall size. In particular the upper edge of this formation may be straight (that is to say parallel to the median plane of the main body 3—cf. FIG. 1), inclined (cf. FIGS. 6, 9 and 10) or of any shape. Moreover, it may be bare or equipped with supplementary functional accessories.

In accordance with possible additional developments, illustrated schematically in FIGS. 4 and 5, there may be provision for the protruding formation 10, preferably in the form of a vertical wall or plate, to include or to be provided with a plate 21 configured to support an electronic circuit card 21′ forming for example part of a management system of the battery 2′, an electrical connection cable 21″ or the like.

In accordance with a first embodiment, illustrated by way of example in FIGS. 1 to 5, the module 1 may include at least two temperature-controlled receiving sites 1′, each site 1′ comprising a covering plate 8 and an associated circuit 4 of fluid circulation ducts, the various circuits 4 being either connected fluidically in series and together to a single pair of feed duct portions 11 and evacuation duct portions 11′ or each connected separately and independently to its own pair of feed duct portions 11 and evacuation duct portions 11′.

In accordance with the second embodiment, illustrated by way of example in FIGS. 6 to 10, the module 1 may comprise a single covering plate 8 and a single circuit of fluid circulation ducts 4, together forming a single temperature-controlled receiving site 1′ on which one or more battery modules 2 is or are intended to come to bear.

In order to achieve efficient exchange of heat and simultaneously to have a maximum exchange area for a given size of the baseplate 6, each circuit of heat transfer fluid FC circulation duct(s) 4 associated with a thermally conducting covering plate 8 is composed of flat duct segments 4′ fluidically connected in series to constitute a serpentine shape arrangement between the inlet 5 and the outlet 5′ of the circuit 4. The set of duct segments 4′ of the circuit 4 thus forms a flattened surface circulation space in the form of a flat blade between the baseplate 6 and the covering plate 8, with a substantially continuous surface extent with the exception of compartmentalization walls 4″ defining the fluidic circulation path in the circuit 4 concerned (FIGS. 6C, 7A, 7B, 10A and 10B).

According to another feature of the invention, and as FIGS. 2, 7A, 7B, 8 and 9 for example show, the or each covering plate 8 is fastened at least peripherally, continuously or not, by means of a material, adhesive or metallic connection 14 or by welding to the baseplate 6 with a continuous liquid seal 9 around the circuit of duct(s) 4 associated with the covering plate 8 concerned, for example by placing a compression seal 9 between the latter and the baseplate 6.

According to an advantageous constructive variant of the invention, emerging for example from FIGS. 7A, 7B, 8 and 9, the or each covering plate 8 may include an edge 8′ forming a peripheral frame, in one piece with it or attached to it, in particular by overmolding, and fastened to the baseplate 6, said edge 8′ advantageously being made of a material allowing welding (for example vibration, laser, hot gas or like welding) to said baseplate 6, the covering plate 8 concerned being if necessary also fastened to the baseplate 6 at one location at least inside the frame 8′, for example at the level of a compartmentalization wall 4″ of said baseplate 6.

In order to preserve the cells in the event of a possible leak of heat transfer liquid FC at the level of the composite plate 3 and to be able to guarantee routing of the leaked liquid to a single predefined location, the invention may provide, as FIGS. 2 and 7B show for example, for a leakage path 15 to be associated with each receiving site 1′, said leakage path 15 comprising a collector groove or channel 15′ extending circumferentially at the periphery and at least one evacuation passage 15″ discharging onto the face of the baseplate 6 opposite the covering plate 8.

The channel or groove 15″ preferably extends between the seal 9 and the peripheral connection 14 between the baseplate 6 and the covering plate 8, the leakage path 15 preferably being formed and situated entirely in the baseplate 6.

In order to facilitate the rigid fastening of the cooling module 1 to the casing 20 in which it is intended to be mounted, the baseplate 6 may be provided with fixing sites 16, such as for example drilled holes, eyelets or the like, formed in the body of said plate 6 or in laterally projecting lugs 16′.

Moreover, when a plurality of cooling modules 1 must be installed in the same casing 20, it may be advantageous to connect them rigidly to one another to form a structural unit as well as a functional unit. A rigid composite plate 3 is also desirable for reliable support of the modules 2′ over time and without damage in the event of impacts.

To this end, the baseplate 6 may include mechanical coupling means 16″ to at least one other module 1 (for example mutually interleavable complementary formations, cooperating fixing lugs or the like) and/or be provided with stiffening formations 6″ (ribs, flanges, thickened portions) on its lower face opposite the covering plate or plates 8.

The invention also has for object as illustrated by way of example in FIGS. 3A, 3B and 11 to 14 a cooling device 17 for the battery 2′ comprising a plurality of cells preferably grouped in modules 2, said device 17 including a plurality of temperature-controlled receiving sites 1′ on which the cells rest, those sites 1′ being all connected to feed and evacuation ducts 18, 18′ that can be connected to a heat transfer fluid FC circulation circuit.

This device 17 is characterized in that it has a modular construction and comprises at least two cooling modules (1) as described hereinabove.

As the aforementioned figures show, this device 17 advantageously comprises four cooling modules 1 arranged in two columns and two rows of two, in such a manner that the protruding formations 10 of two modules 1 are in each case coplanar and the inlet and outlet ports 13, 13′ of their respective duct portions 11 and 11′ are situated facing each other, the two pairs of aligned protruding formations 10 of the two pairs of modules 1 being situated at the level of mutually opposite sides of said arrangement of modules 1.

The feed and evacuation ducts 18 and 18′ preferably connect the feed and evacuation duct portions 11, 11′ of the various cooling modules 1 between them and to an external heat transfer fluid circulation circuit (not represented), forming a feed line and an evacuation line, each duct 18, 18′ being equipped with connectors 18″ coming to be engaged in sealed manner in the inlet and outlet portions 13, 13′ of the various cooling modules 1, for example by nesting therein. Connecting means (connectors 18′″ or other connecting means) for connecting these ducts 18, 18′ to the external circuit (not represented) are also provided, of course.

In order to compensate manufacturing and assembly variations, and possibly mechanical deformation or thermal expansion, without compromising the seal of the heat transfer liquid FC circulation lines, the feed duct and/or the evacuation duct 18, 18′, preferably each of the two, is constituted of two aligned duct parts 22 connected by a sealed and axially sliding connection 22′, for example equipped with at least one O-ring (cf. FIGS. 12C and 15B).

An arrangement of the cooling modules 1 to form a cooling device 17 as represented in FIGS. 11, 12 and 14 enables the battery cells and modules 2 to be enclosed in a retaining structure in the casing 20 (bottom tray) and (thermal, physical) insulation/isolation relative to the latter, as FIGS. 11 to 15 show, whilst allowing with a standard base module (module 1—for example available in two variants with different inclinations of the upper edges of the formations 10) constructive adaptability with flexibility of adaptation in terms of size and configuration.

Of course, a battery unit may include only one cooling device 17. However, for large battery sizes, with a large number of modules 2, where applicable arranged in a staggered manner, a plurality of separate cooling devices may be provided that may be fluidically connected to one another.

In this case, at least one of the feed and/or evacuation ducts 18, 18′, preferably both of them, is (are) provided with a connector 23 for connection to an ancillary circulation circuit, where applicable to another cooling device 17.

The invention is also aimed at a temperature-managed battery unit 2′ comprising cells grouped into a plurality of battery modules 2 and a protection casing 20 (only its bottom tray is represented, which is closed by an upper lid not represented).

This battery unit is characterized in that it also comprises at least one cooling device 17 as described hereinabove mounted in the casing 20 and including a plurality of cooling modules 1, preferably four of them, advantageously connected mechanically and fluidically to one another, and providing a plurality of receiving sites 1′ for said battery modules 2.

The casing 20 may in particular include a fluid-tight tray (cf. FIGS. 15A and 15B) for containing any links of heat transfer liquid FC whist featuring passages (if necessary sealed passages) for connecting the fluid circulation lines to the ducts 18, 18′, preferably at the level of a lateral wall of the tray of the casing 20, at a distance from the bottom.

Finally, the invention also relates to an in particular electric or hybrid automobile vehicle characterized in that it comprises at least one battery unit 2′ of the type mentioned hereinabove in which the or each cooling device 17 is connected to the engine cooling circuit of said vehicle.

Of course, the invention is not limited to the embodiments described and represented in the appended drawings. Modifications remain possible, in particular from the point of view of the constitution of the various elements or by substitution of technical equivalents, without this departing from the scope of protection of the invention.

1. A cooling module for cells or module(s) of an electric battery, in particular a hybrid or electric vehicle battery, comprising:
a main body in the form of a composite plate, preferably of rectangular shape and integrating at least one circuit for the circulation of a heat transfer fluid with a fluid inlet and a fluid outlet, this composite plate comprising a baseplate made of a rigid material with low thermal conductivity, in which is formed an array of channels, and at least one covering plate made of a material with high thermal conductivity, which is mounted on the baseplate and forms an at least peripheral seal, which through cooperation with the channels of the baseplate, forms the duct or ducts or duct segment(s) of the circuit(s) and is intended to come into surface contact with cells or at least one module of the battery to be cooled, each [cover plate/circuit of duct(s) assembly forming a temperature-controlled reception site,
wherein said cooling module also comprises, along one of the lateral sides of the composite plate, a protruding formation that is inclined relative to said composite plate, which integrates feed and evacuation duct portions respectively connected to the fluid inlet and to the fluid outlet of the or each of the circuits of duct(s) of the composite plate, which is made of a material with low thermal conductivity, and at least one part of which, preferably a major part including channels corresponding to the feed and evacuation duct portions, and is produced in one piece with the baseplate of the main body.

2. The cooling module as claimed in claim 1, wherein the protruding formation takes the form of a plate portion extending perpendicularly to the median plane of the composite plate and extending in continuity therewith a lateral edge of the baseplate, preferably an edge corresponding to a width of the rectangle formed by the composite plate.

3. The cooling module as claimed in claim 1, wherein the protruding formation is provided, at the level of the ends of the feed and evacuation duct portions, which are situated opposite their ends communicating with the fluid inlet and the fluid outlet of the or each circuit of duct(s) integrated in the composite plate, feed and evacuation ports or connectors offset relative to the median plane of the composite plate, advantageously situated at a distance above the covering plate concerned and discharging laterally from said formation, for example from a lateral edge surface of the latter.

4. The cooling module as claimed in claim 1, wherein the protruding formation integrating feed duct portions and evacuation duct portions and having an overall constitution in the form of a plate portion has a composite structure and comprises a base body in which are formed channels corresponding to the feed duct portions and evacuation duct portions and a complementary plate delimiting through cooperation with said channels said duct portions, the inlet connectors or ports and outlet connectors or ports of the latter discharging laterally at the level of an edge surface of said plate portion.

5. The cooling module as claimed in claim 1, wherein each circuit of heat transfer fluid circulation duct(s) associated with a thermally conducting covering plate is composed of flat duct segments fluidically connected in series to constitute an arrangement of serpentine shape between the inlet and the outlet of the circuit, the set of duct segments of the circuit forming a flattened surface circulation space in the form of a flat blade between the baseplate and covering plate, with a surface extent that is continuous with the exception of compartmentalization walls defining the fluidic circulation path in the circuit concerned.

6. The cooling module as claimed in claim 1, wherein the or each covering plate is fastened at least peripherally, continuously or not, by means of a material, adhesive or mechanical connection or by welding to the baseplate with a continuous liquid seal produced around the duct circuit associated with the covering plate concerned, for example by placing a compression seal between the latter and the baseplate.

7. The cooling module as claimed in claim 6, wherein the or each covering plate includes an edge forming a peripheral frame, in one piece or attached, in particular by overmolding, that is fastened to the baseplate, said edge being advantageously made of a material allowing welding to said baseplate, the covering plate concerned being where appropriate also fastened to the baseplate at at least one location inside the frame, for example at the level of a compartmentalization wall of said baseplate.

8. The cooling module as claimed in claim 1, wherein a leakage path is associated with each receiving site, said leakage path including a collector groove or channel with peripheral circumferential extent and at least one evacuation passage discharging onto the face of the baseplate opposite the covering plate.

9. The cooling module as claimed in claim 6, wherein the channel or groove extends between the seal and the peripheral connection existing between the baseplate and recovering plate, the leakage path preferably being formed and situated entirely in the baseplate.

10. The cooling module as claimed in claim 1, wherein said cooling module comprises a single covering plate and a single fluidic circulation duct circuit together forming a single temperature-controlled receiving site on which are intended to come to bear one or more battery modules.

11. The cooling module as claimed in claim 1, wherein said cooling module includes at least two distinct temperature-controlled receiving sites, each site comprising a covering plate and an associated fluidic circulation duct circuit, the various circuits being either connected fluidically in series and together to a single pair of feed duct portions and evacuation duct portions or each connected separately and independently to its own pair of feed duct portions and evacuation duct portions.

12. The cooling module as claimed in claim 1, wherein the baseplate is provided with fixing sites, such as for example drilled holes, eyelets or the like, formed in the body of said plate or in laterally projecting lugs, and where applicable with mechanical coupling means to at least one other module and/or stiffener formations on its lower face opposite the covering plate or plates.

13. The cooling module as claimed in claim 4, wherein the baseplate and the base body have a monobloc part molded from thermoplastic material, the or each covering plate have a metal, preferably aluminum, plate.

14. The module as claimed in claim 1, wherein the protruding formation, preferably in the form of a vertical wall or plate, includes or I provided with a plate configured to support an electronic circuit card forming for example part of a management system of the battery, an electric connection cable or the like.

15. A cooling device for a battery comprising: a plurality of cells, preferably grouped in modules, said device including a plurality of temperature-controlled receiving sites on which the cells rest, these sites being all connected to feed and evacuation ducts that can be connected to a heat transfer fluid circulation circuit, device wherein said cooling device has a modular structure and comprises at least two cooling modules as claimed in claim 1.

16. The cooling device as claimed in claim 15, wherein said cooling device comprises four cooling modules arranged in two columns and two rows of two, in such a manner that the protruding formations of two modules are in each case coplanar and the inlet and outlet ports of their respective duct portions are situated facing one another, the two pairs of aligned protruding formations of the two pairs of modules being situated at the level of sides of said arrangement of modules facing one another.

17. The cooling device as claimed in claim 15, wherein the feed and evacuation ducts connect the feed and evacuation duct portions of the various cooling modules to one another and to an external heat transfer fluid circulation circuit, forming a feed line and an evacuation line, each duct being equipped with connectors coming to engage in sealed manner in the inlet and outlet ports of the various cooling modules, for example by nesting therein.

18. The cooling device as claimed in claim 15, wherein the feed duct and/or the evacuation duct, preferably each of the two, is constituted of two duct parts aligned and connected by a sealed axially sliding connection, for example equipped with at least one O-ring.

19. The cooling device as claimed in claim 15, wherein at least one of the feed and/or evacuation ducts, preferably both, is (are) provided with a connector for connection to an ancillary circulation circuit, where appropriate to another cooling device.

20. A temperature-controlled battery unit comprising: cells grouped into a plurality of battery modules and a protection casing, unit wherein said temperature-controlled battery unit also comprises at least one cooling device as claimed in any one of claims 15 to 19 mounted in the casing and including a plurality of cooling modules, preferably four of them, advantageously connected mechanically and fluidically to one another and providing a plurality of receiving sites for said battery modules.

21. An electric or hybrid automobile vehicle, wherein said electric or hybrid automobile vehicle includes at least one battery unit as claimed in claim 20 the or each cooling device of which is connected to the engine cooling circuit of said vehicle.
